(19) United States
(12) Patent Application Publication
(10) Pub. No.: US 2025/0346278 A1
(43) Pub. Date: Nov. 13, 2025

(54) Icehouse Floor Sled Device

(71) Applicant: Michael Norlen, Two Harbors, MN (US)

(72) Inventor: Michael Norlen, Two Harbors, MN (US)

(21) Appl. No.: 19/098,516

(22) Filed: Apr. 2, 2025

Related U.S. Application Data
(60) Provisional application No. 63/643,454, filed on May 7, 2024.

(51) Int. Cl. B62B 13/02; A01K 97/01; B62B 15/00; B62B 17/00

(52) U.S. Cl. CPC B62B 13/02; B62B 15/007; B62B 17/00; A01K 97/01

(57) ABSTRACT

An icehouse floor sled device is provided. The device is comprised of a corrosion-resistant frame that may receive an icehouse. The device incorporates features such as runners for smooth movement on snow or ice, a foldable design with locking hinges for compact storage, and a hitch adaptable to various towing vehicles. A polycarbonate floor provides a stable surface, with customizable openings for ice augers that can be sealed securely with threaded lids. The device includes dedicated receiving areas for safely securing equipment, such as molded recesses for propane canisters and vertically aligned posts with cushioned grips for ice augers. Fasteners and vibration-dampening mounts ensure stability during transport, while modular and adjustable components offer user-friendly customization.

### CROSS-REFERENCE TO RELATED APPLICATION

The present application claims priority to, and the benefit of, U.S. Provisional Application No. 63/643,454, which was filed on May 7, 2024, and is incorporated herein by reference in its entirety.

### FIELD OF THE INVENTION

The present invention relates generally to the field of icehouses. More specifically, the present invention relates to an icehouse floor sled device that can be used as the floor of an icehouse structure to allow the icehouse to be easily moved via a towing vehicle. Accordingly, the present disclosure makes specific reference thereto. Nonetheless, it is to be appreciated that aspects of the present invention are also equally applicable to other like applications, devices, and methods of manufacture.

### BACKGROUND

People may choose to use an icehouse for fishing during the winter months, as it provides shelter and comfort while they pursue their hobby on frozen lakes. However, transporting all of the necessary ice fishing gear can be a challenging and time-consuming task. Anglers often need to find adequate space to carry a wide range of equipment, including a heavy ice auger, multiple fishing poles, tip-ups, tackle boxes, bait, a heater, a gas or propane canister, and various other essential items. The logistics of organizing and securing this gear in a vehicle or sled for the journey to the fishing location can be cumbersome, especially when navigating icy terrain or snow-covered paths.

Once anglers have selected a fishing spot and unloaded all of their equipment, setting up the icehouse and preparing the gear requires considerable effort. The process involves drilling holes through the thick ice, arranging fishing lines, positioning tip-ups, and assembling the icehouse to provide warmth and wind protection. Due to the significant amount of time and physical work involved in establishing a fishing setup, it can be difficult for anglers to relocate to a different spot if the fish aren't biting. Moving to a new location often means breaking down the entire setup, packing up all the gear, and repeating the labor-intensive process, which can be discouraging and lead to missed fishing opportunities throughout the day.

Therefore, there exists a long-felt need in the art for a device that allows a user to easily move an icehouse. There also exists a long-felt need in the art for an icehouse floor sled device that allows a user to easily move an icehouse via a vehicle. In addition, there exists a long-felt need in the art for an icehouse floor sled device that allows a user to easily move an icehouse via a vehicle, wherein the device can accommodate a plurality of icehouse types and configurations.

The subject matter disclosed and claimed herein, in one embodiment thereof, comprises an icehouse floor sled device. The device is comprised of a corrosion-resistant frame that may receive an icehouse. The device incorporates features such as runners for smooth movement on snow or ice, a foldable design with locking hinges for compact storage, and a hitch adaptable to various towing vehicles. A polycarbonate floor provides a stable surface, with customizable openings for ice augers that can be sealed securely with threaded lids. The device includes dedicated receiving areas for safely securing equipment, such as molded recesses for propane canisters and vertically aligned posts with cushioned grips for ice augers. Fasteners and vibration-dampening mounts ensure stability during transport, while modular and adjustable components offer user-friendly customization.

In this manner, the icehouse floor sled device of the present invention accomplishes all the foregoing objectives and provides a device that allows a user to easily move an icehouse by securing the icehouse to the device. The device also allows a user to easily move an icehouse via a vehicle using the hitch. In addition, the device can accommodate a plurality of icehouse types and configurations.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an icehouse floor sled device. The device comprises a frame, preferably rectangular or square, made from durable, corrosion-resistant materials like anodized aluminum or stainless steel to ensure strength and lightweight construction. The frame includes at least one runner designed for smooth travel over snow and ice, with options for reinforced or low-friction configurations, and may be textured to enhance traction.

The frame features a hitch for towing, compatible with various vehicles such as ATVs or snowmobiles. This hitch may be adjustable to fit different towing heights. The frame can also be foldable, facilitated by locking hinges that secure in place when deployed, with actuation mechanisms like push-buttons or slide-locks.

A polycarbonate floor surface is mounted on the frame, offering durability and weather resistance. The floor incorporates at least one opening for ice augers, with a customizable size. The opening can be sealed with a lid featuring handles for easy use, and some lids may be threaded for a secure seal against the elements. Mounting structures are included for attaching shelters, with options like fixed or quick-release brackets and a rail-based system for adjustability.

Additional receiving areas on the frame or floor are designed to hold essential equipment securely. A molded recess holds gas or propane canisters, equipped with integrated fasteners such as heavy-duty straps or adjustable clamps for stability during transport. An area for securing an ice auger includes a vertical post with a cushioned sleeve to prevent damage, supplemented by fasteners like ratcheting straps or locking collars.

Accordingly, the icehouse floor sled device of the present invention is particularly advantageous as it provides a device that allows a user to easily move an icehouse by securing the icehouse to the device. The device also allows a user to easily move an icehouse via a vehicle using the hitch. In addition, the device can accommodate a plurality of icehouse types and configurations.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective top view of one potential embodiment of an icehouse floor sled device of the present invention in accordance with the disclosed architecture;

FIG. 2 illustrates a perspective side view of one potential embodiment of an icehouse floor sled device of the present invention in accordance with the disclosed architecture; and

FIG. 3 illustrates a perspective view of an opening and a lid of one potential embodiment of an icehouse floor sled device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to easily move an icehouse. There also exists a long-felt need in the art for an icehouse floor sled device that allows a user to easily move an icehouse via a vehicle. In addition, there exists a long-felt need in the art for an icehouse floor sled device that allows a user to easily move an icehouse via a vehicle, wherein the device can accommodate a plurality of icehouse types and configurations.

The present invention, in one exemplary embodiment, is comprised of an icehouse floor sled device. The device includes a frame, preferably rectangular or square, constructed from durable, corrosion-resistant materials such as anodized aluminum or stainless steel to ensure both strength and lightweight design. The frame features at least one runner, engineered for smooth movement over snow and ice, with options for reinforced or low-friction setups, and may also include texturing to improve traction.

The frame is equipped with a hitch for towing, designed to be compatible with various vehicles like ATVs or snowmobiles, and the hitch may be adjustable to accommodate different towing heights. Additionally, the frame can be foldable, using locking hinges that secure in place when in use, with mechanisms such as push-buttons or slide-locks for ease of operation.

A polycarbonate floor surface is mounted to the frame, offering durability and resistance to weather conditions. The floor includes at least one opening for ice augers, which can be customized in size and sealed with a lid that has handles for convenience. Some lids may be threaded to ensure a secure, weather-resistant seal. Mounting structures are provided for attaching shelters, offering options like fixed or quick-release brackets and a rail-based system for adjustability.

Additional receiving areas on the frame or floor are designed to securely hold essential gear. A molded recess accommodates gas or propane canisters, using integrated fasteners like heavy-duty straps or adjustable clamps for stability during transport. The area designated for an ice auger includes a vertical post with a cushioned sleeve to prevent damage, secured with fasteners such as ratcheting straps or locking collars.

Overall, the icehouse floor sled device of the present invention is particularly beneficial as it enables users to easily transport an icehouse by securing it to the device. The device also facilitates moving the icehouse with a vehicle using the hitch and accommodates a variety of icehouse types and configurations.

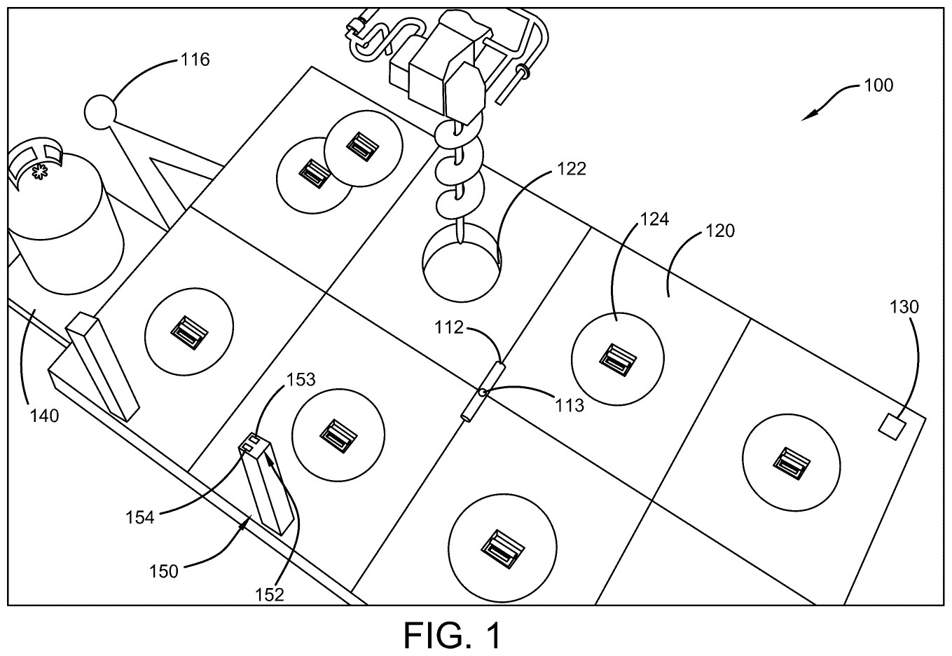

Referring initially to the drawings, FIG. 1 illustrates a perspective top view of one potential embodiment of an icehouse floor sled device 100 of the present invention in accordance with the disclosed architecture. The device 100 is comprised of a frame 110 that is preferably rectangular or square in shape, although other geometric configurations may be implemented depending on specific user requirements or design constraints. The frame 110 is preferably constructed from aluminum or another durable metal material to provide structural integrity while minimizing weight. To ensure long-term durability in harsh outdoor conditions, the frame 110 is made from corrosion-resistant material, which may include anodized aluminum, stainless steel, or a metal alloy treated with anti-corrosive coatings.

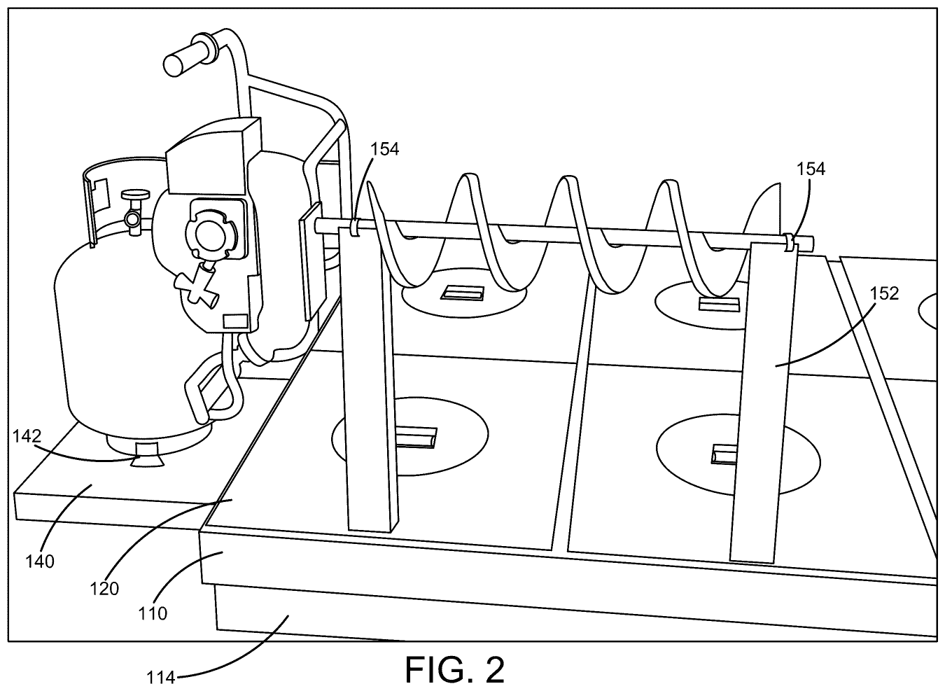

The frame 110 comprises at least one runner 114 (as seen in FIG. 2), which functions to facilitate the smooth movement of the device 100 over snow and/or ice surfaces. The runner 114 may be implemented in various forms, shapes, and configurations, such as a reinforced runner designed for strength or a low-friction ski to minimize resistance and ease of towing. These variations can be tailored to optimize performance under different environmental conditions. The runner 114 may also be comprised of an anti-corrosion material. The runner 114 may also be textured to enhance traction on icy terrain.

Additionally, the frame 110 may comprise at least one hitch 116 (as seen in FIG. 1), which enables the attachment of the device 100 to an all-terrain vehicle (ATV), snowmobile, or other motorized vehicle for efficient towing and transport. The hitch 116 may be any of several types, including, but not limited to, a ball hitch, a pintle hitch, or a clevis hitch, to provide compatibility with a wide range of towing mechanisms. To enhance usability, the hitch 116 may be comprised of an adjustable height hitch to accommodate different towing vehicle configurations.

In an embodiment designed for convenient storage and transport, the frame 110 is foldable. This folding feature is enabled by at least one locking hinge 112. The locking hinge 112 allows the frame 110 to be collapsed when not in use and then securely locked in place when deployed. Each locking hinge 112 can be engaged or disengaged via at least one button 113, which may be a push-button, a slide-lock mechanism, or another suitable actuation system.

A floor surface 120 is positioned atop the frame 110, providing a stable surface for standing or mounting additional components. The floor 120 is preferably made from polycarbonate for its combination of strength, durability, and resistance to harsh weather conditions. The floor 120 comprises at least one opening 122, which can be customized in size to accommodate various sizes of ice augers. The opening 122 allows for efficient ice drilling without needing to move or reposition the entire device 100.

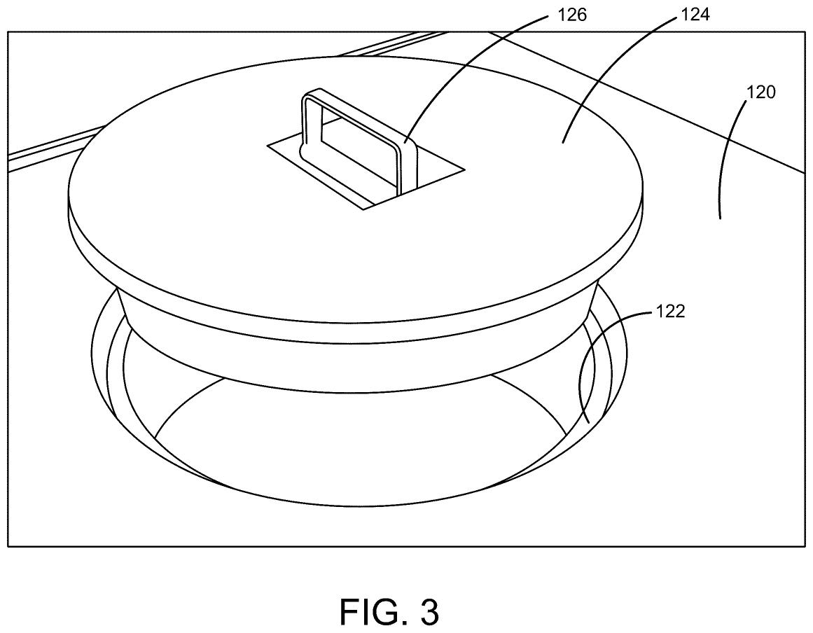

When the opening 122 is not in use, it can be sealed with at least one lid 124, as seen in FIG. 1. The lid 124 may feature at least one handle 126 (as seen in FIG. 3) for ease of removal and replacement of the lid 124 from the opening 122. In one embodiment, the opening 122 is threaded, and the corresponding lid 124 is also threaded, allowing the lid 124 to be securely screwed into place, providing a tight seal to prevent water or snow ingress. The lid 124 and opening 122 may be any type of reciprocating components with reciprocating fasteners. The handle 126 can be of any type, such as a loop handle, a recessed pull, or a lever-style grip, to facilitate operation even when wearing gloves.

The frame 110 and/or floor 120 may further comprise at least one mounting structure 130, designed to allow for attachment of an icehouse or similar shelter to the device 100. The mounting structure 130 can take several forms. One form is comprised of a fixed mounting bracket for permanent attachment, while another is a quick-release bracket that facilitates rapid assembly and disassembly. In one embodiment, a rail-based system could be incorporated to allow for sliding and repositioning of the shelter along the frame 110.

Moreover, the frame 110 and/or floor 120 may include multiple receiving areas to secure and organize essential equipment. One receiving area 140 is specifically intended for holding a gas or propane canister. This receiving area 140 is engineered as a molded recess that conforms closely to the shape of the canister, providing a snug and secure fit that minimizes any risk of lateral or vertical movement. The molded recess is supplemented with integrated fasteners 142 (as seen in FIG. 2), which may include, but are not limited to, heavy-duty straps made from weather-resistant nylon, adjustable clamps with rubberized grips to prevent slippage, or even spring-loaded locking arms for enhanced stability. These fasteners 142 are strategically positioned to ensure that the canister remains immobilized even under the stress of rapid towing over uneven or bumpy surfaces.

Similarly, the device 100 is comprised of at least one dedicated receiving area 150 for securing an ice auger. This receiving area 150 preferably comprises a vertically aligned post 152, constructed from high-strength, corrosion-resistant material to endure repeated use and exposure to harsh environments. The post 152 may include a cushioned sleeve or rubber lining 153 to grip the auger's shaft securely without causing scratches or abrasions to the auger's surface. The auger is further immobilized by at least one fastener 154 (as seen in FIG. 2), which could be implemented in multiple configurations. Examples of fasteners 154 include adjustable ratcheting straps with quick-release buckles for swift deployment, clamps that can be tightened or loosened based on the auger's diameter, or a locking collar system with integrated cam levers.

To provide additional protection and convenience, the receiving area 150 may be outfitted with retention mechanisms such as vibration-dampening mounts that reduce rattling during movement. It may also feature a stabilizing bracket at the base to hold the auger's blades or cutting edges, preventing wear and ensuring that the auger remains in optimal working condition. In certain embodiments, this area 150 may be equipped with a modular design that allows for repositioning or customization, enabling users to adjust the layout of the equipment based on their unique operational needs.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “icehouse floor sled device” and “device” are interchangeable and refer to the icehouse floor sled device 100 of the present invention.

Notwithstanding the foregoing, the icehouse floor sled device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the icehouse floor sled device 100 as shown in the FIGS. are for illustrative purposes only, and that many other sizes and shapes of the icehouse floor sled device 100 are well within the scope of the present disclosure. Although the dimensions of the icehouse floor sled device 100 are important design parameters for user convenience, the icehouse floor sled device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An icehouse floor sled device comprising:
a frame;
a runner attached to the frame;
a hitch attached to the frame;
a floor surface positioned atop the frame, the floor surface comprised of an opening;
a lid configured to seal the opening when not in use, the lid comprised of a handle; and
a mounting structure positioned on the floor or the frame.

2. The icehouse floor sled device of claim 1, wherein the hitch is comprised of a ball hitch.

3. The icehouse floor sled device of claim 1, wherein the locking hinge is comprised of a button.

4. The icehouse floor sled device of claim 1, wherein the mounting structure is comprised of a mounting bracket.

5. The icehouse floor sled device of claim 1, wherein the handle is comprised of a recessed pull handle.

6. The icehouse floor sled device of claim 1, wherein the frame is comprised of an aluminum material.

7. The icehouse floor sled device of claim 1 further comprised of a gas canister receiving area.

8. The icehouse floor sled device of claim 1 further comprised of an auger receiving area.

9. An icehouse floor sled device comprising:
a frame comprised of a runner;
a hitch coupled to the frame;
a floor surface secured to the frame, the floor surface having a threaded opening and a corresponding threaded lid;
a mounting structure; and
a receiving area comprised of a fastener.

10. The icehouse floor sled device of claim 9, wherein the hitch assembly is comprised of a height adjustable hitch.

11. The icehouse floor sled device of claim 9, wherein the runner is comprised of a low-friction ski.

12. The icehouse floor sled device of claim 9, wherein the runner is comprised of a textured runner.

13. The icehouse floor sled device of claim 9, wherein the hitch is comprised of a pintle hitch or a clevis hitch.

14. The icehouse floor sled device of claim 9, wherein frame is comprised of a hinge.

15. The icehouse floor sled device of claim 9, wherein the receiving area is comprised of a molded recess.

16. The icehouse floor sled device of claim 9, wherein the receiving area is comprised of a vertical post.

17. The icehouse floor sled device of claim 9, wherein the floor surface is comprised of a polycarbonate floor.

18. An icehouse floor sled device comprising:
a frame constructed from a corrosion-resistant material;
a hitch attached to the frame;
a runner affixed to the frame;
a floor surface positioned atop the frame, the floor surface having an opening;
a lid configured to cover the opening, the lid including a handle;
a mounting structure affixed to the frame or the floor surface;
a first receiving area comprising a molded recess with a first fastener; and
a second receiving area comprising a vertical post and a second fastener.

19. The icehouse floor sled device of claim 18, wherein the first fastener is comprised of a strap or a clamp.

20. The icehouse floor sled device of claim 18, wherein the second fastener is comprised of a ratcheting strap, a clamp, or a locking collar.
